(19) United States
(12) Patent Application Publication
(10) Pub. No.: US 2020/0102755 A1
(43) Pub. Date: Apr. 2, 2020

(54) T-BAR CLAMP FOR SUSPENDED CEILING GRID AND METHOD OF USE

(71) Applicants: Kenneth George Langtry, Saanichton, (CA); Walter Maurice Gotsch, Chatham, NJ (US)

(72) Inventors: Kenneth George Langtry, Saanichton, (CA); Walter Maurice Gotsch, Chatham, NJ (US)

(21) Appl. No.: 16/146,512

(22) Filed: Sep. 28, 2018

(51) Int. Cl. E04F 13/22; F16M 13/02; E04F 13/00; F16B 2/22

(52) U.S. Cl. CPC E04F 13/22; F16B 2/22; E04F 13/002; F16M 13/027

(57) ABSTRACT

An assembly for coupling polyethylene or similar sheeting to a suspended ceiling system to form a temporary curtain barrier. A first component has a pointed shaft configured to pierce through the sheeting, and a pair of opposing jaws configured to grip opposing edges of a T-shaped rail of the ceiling system. A second component is configured to engage the shaft of the first component to lock the first component to the tee and trap the sheeting impaled on the shaft.

### CROSS-REFERENCE TO RELATED APPLICATION

This application claims the benefit under 35 U.S.C. § 119(e) of U.S. Provisional Patent Application No. 62/605,738, filed 23 Aug. 2017, which provisional application is incorporated herein by reference in its entirety.

### BACKGROUND

### Technical Field

The present disclosure is directed to a device for use with a suspended ceiling grid, and in particular, to a device configured to temporary attach a barrier or curtain of, e.g., polyethylene film to T-rails or similar members of a ceiling grid.

### Background Information

In the building trades, circumstances sometimes require that a portion of a building be isolated or even hermetically sealed from other portions of the building. Such circumstances can include, for example, the removal of asbestos-bearing materials from the portion of the building in order to prevent contamination of other portions of the building by asbestos particles, remodeling or renovating of the portion of the building, in order to prevent dust and/or paint or other chemical vapors from entering portions of the building that are still occupied, etc.

Typically, the isolation of one portion of a building from another involves the installation of ceiling-to-floor barriers of one or two layers of heavy-gauge (4-6 mil) polyethylene sheeting around an entire perimeter of the portion to be isolated, and also, frequently, just below the ceiling and/or above the floor.

The isolated portion is then typically maintained at a slight negative atmospheric pressure in order to ensure that any leaks in the enclosure are of clean outside air into the isolated portion, and not of contaminated air moving outward. The slight negative pressure is typically maintained using a blower and air filtration unit to suck airfrom the isolated portion, filter or scrub it, and then release it into the environment. The system works most efficiently when there are no leaks in the isolation system.

Although simple in concept, installation of such barriers is laborious and time consuming in practice. Creating a vertical barrier requires suspending the flexible sheeting from a ceiling or other overhead at multiple connection points, at relatively close spacing in order to avoid excessive sag between connections. Consequently, constructing even a modestly sized barrier involves numerous such connections, while in larger projects the connections may number in the hundreds or even thousands. Even a relatively brief amount of time spent making each connection therefore tends to have a serious cumulative effect in terms of overall labor costs and delay. Moreover, the impact is compounded by the reality that the barriers must be moved about and reinstalled from time-to-time, as the job progresses, for ingress/egress of equipment or supplies, and so on.

In commercial projects with suspended ceilings, T-bars forming the ceiling grid commonly provide opportune supports for suspending such barriers. However, the mechanisms employed to form the actual connections have generally been less than satisfactory in a number of respects. In some instances, personnel resort to ad hoc approaches such as attaching the sheeting to the T-bars using twisted wire, adhesive tape and so on, which is not only highly inefficient but also creates unsatisfactory connections that are subject to frequent failure. While some dedicated hooks or connector pieces have provided for attachment to T-bars, these have nevertheless remained somewhat cumbersome and time-consuming to install. For example, some connectors provide inadequate grip or support to prevent the sheeting from slipping or tearing, while some also require two hands to install, making it difficult to hold up and attach the sheeting without need for a separate step. Moreover, some connectors are comparatively expensive to manufacture and/or capable of only single use, again adding to the cost of the job.

### SUMMARY OF THE INVENTION

According to an embodiment, an assembly for coupling barrier sheeting material, such as, e.g., polythene (PE) sheeting, to a suspended ceiling system is provided, in which the assembly includes first and second components. The first component has a pointed shaft configured to pierce through the sheeting and a pair of jaws configured to grip opposing edges of a flange of a tee of the ceiling system. The second component is configured to mate with the first component, thereby locking the first component to the tee, and applying gripping force to the sheeting material impaled on the shaft.

According to an embodiment, the first and second components are each formed as respective single pieces.

According to an embodiment, the jaws of the first component are configured to be separable against a spring bias to permit engagement of the flange by the jaws, and the second component is configured to lock the jaws in engagement with the flange.

According to an embodiment, the second component is configured apply the gripping force to the sheeting material by applying a spring bias against a surface of the flange, with the sheet material between the second component and the flange.

These and other features and advantages of the invention will be more fully appreciated from a reading of the following detailed description with reference to the accompanying drawings.

### BRIEF DESCRIPTION OF THE DRAWINGS

FIG. 1 is a perspective view of a clip assembly, according to an embodiment, configured to be attached to a suspended ceiling grid and to grip sheeting material for use in forming temporary isolation barriers;

FIG. 2 is a front perspective view of a male component of the clip assembly of FIG. 1;

FIG. 3 is a side perspective view of a female component of the clip assembly of FIG. 1;

FIGS. 4 and 5 are cross-sectional views of a portion of a temporary isolation system that includes a plurality of the clip assemblies of FIGS. 1-3 mounted to T-rails of a suspended ceiling grid, a representative one of the clip assemblies being shown in FIGS. 4-5, FIG. 4 being an X-Z plane cross-section taken along lines 4-4 in FIG. 5 and FIG. 5 being a Y-Z plane cross-section taken along lines 5-5 in FIG. 4; and

FIGS. 6-9 are sequential perspective views illustrating steps in installing the components of the clip assembly on a T-rail together with the sheeting material to form the temporary isolation system shown in FIGS. 4-5.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

Arrows indicating X, Y, and Z-axes are provided in many of the drawings. These are intended to aid a viewer in recognizing the relative orientations of the elements in the drawings, and to simplify the description. Unless explicitly described otherwise, neither the language used in the description nor the orientation of the structures depicted in the drawings is intended to suggest any necessary orientation of physical structures on which the claims read. Accordingly, unless defined otherwise, the claims can be read on any structure that otherwise conforms to the claim language, without regard to its physical orientation.

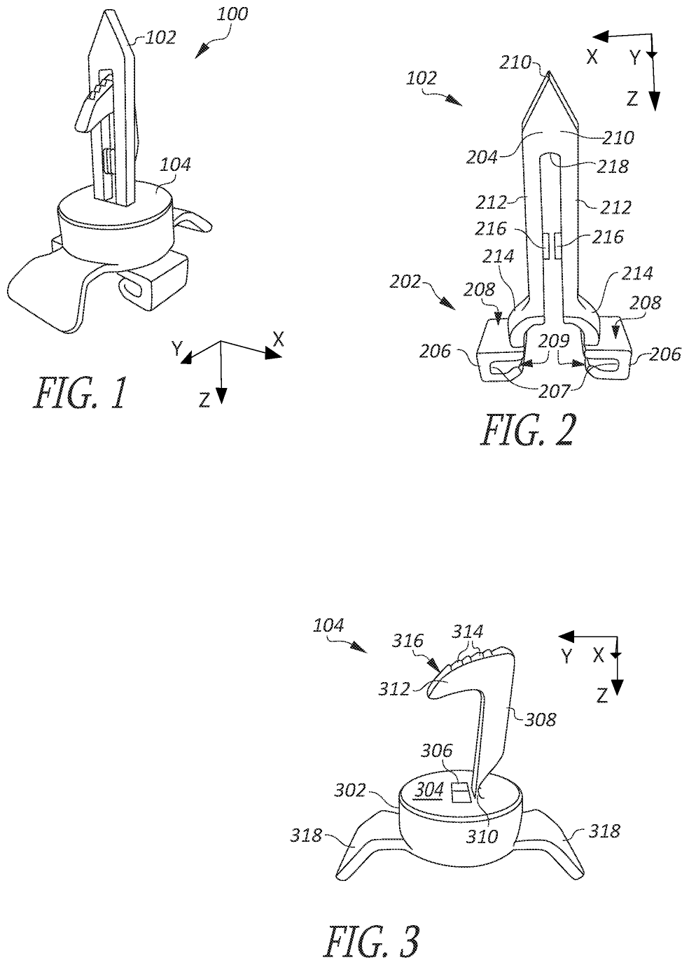

FIG. 1 is a perspective view of a clip assembly 100, according to an embodiment of the invention. The clip assembly includes a male component 102 and a female component 104. FIG. 2 is a front perspective view of the male component 102, and FIG. 3 is a side perspective view of the female component 104. According to an embodiment, the male and female components 102, 104 of the clip assembly 100 are monolithic, i.e., each is formed as a respective single piece of, for example, plastic or resin, having high strength and a limited degree of stiffness/flexibility depending upon a material thickness. Examples of suitable materials include injection molded polypropylene, polythene, abs, nylon and so on.

Referring primarily to FIG. 2, the male component 102 includes a base 202 and a shaft 204 extending outward from the base. The base 202 includes a pair of jaws 206, each having an inner face 207, a shoulder surface 208, and a mouth 209. The jaws 206 face each other, and are each configured to engage the edge of a relatively thin element or member lying parallel to an X-Y plane, for example, the horizontal lower flange of a T-bar forming part of a suspended ceiling grid. Their relative orientation enables the pair of jaws 206 to engage opposite edges of such an element whose width falls within a selected range, e.g., a width approximately equal to or less than a distance between the respective inner faces 207 but not less than a distance between their respective mouths 209.

The shaft 204 of the male component 102 includes a point 210 at a first distal end 211, which is preferably sharpened, at least to the extent necessary to pierce heavy gauge polyethylene (PE) or other sheeting of the type used in temporary area isolation barriers. The shaft 204 further includes a pair of legs 212 extending longitudinally and substantially parallel to each other from the first end toward a second, base end of the shaft, and a pair of feet 214 at the second end of the shaft, coupled to respective ones of the legs 212. The feet 214 which may be roughly arcuate in shape, connect the legs 212 to the shoulder surfaces 208 of the respective jaws 206. The shape of the feet 214 and the locations at which they connected to the shoulder surfaces 208 results in the jaws 206 being spaced further apart than the legs 212.

Ratchet stop tabs 216, the function of which will be explained below, are positioned so as to face each other on inner surfaces of respective ones of the legs 212, near a midpoint of the legs. Rather than a pair, some embodiments may employ a single stop tab or corresponding structure. A pawl edge 218, in turn, is located in a web region where the legs 212 are joined, near the first end 211 (FIG. 5 shows the pawl edge 218 most clearly).

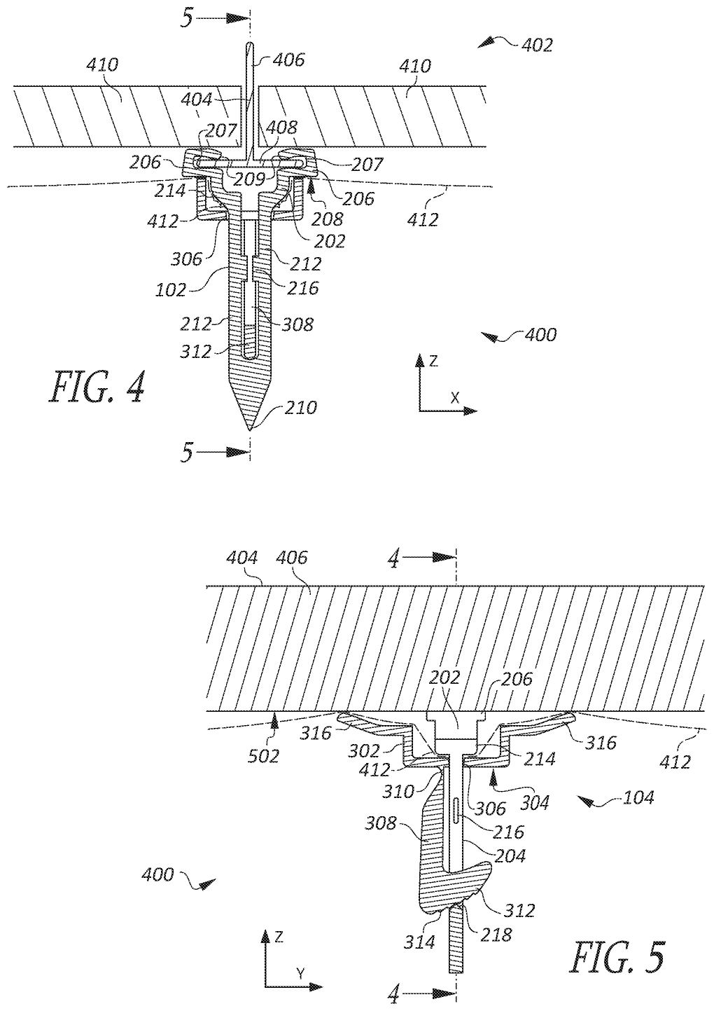

Referring now to FIG. 3, the female component 104 includes a disk-shaped body 302. The body 302 is hollow, opening towards a base side, and has a first, upper surface, as viewed in FIG. 3 that is substantially planar, with an aperture 306 approximately centered in the first surface and extending from the first surface through to the hollow interior of the body. A side of the body 302 opposite the first surface 304 is open, as better seen in FIGS. 4 and 5. The ratchet arm 308 is coupled to the body 302, by a narrowed hinge region 310, in a position adjacent to the aperture 306 and approximately centered on the body, in the X axis. The ratchet arm 308 includes a ratchet head 312, at an end of the ratchet arm opposite the narrowed region 310, that extends over the aperture 306. The ratchet head 312 includes a plurality of engagement notches 314 along a somewhat arcuately curved outer surface 316, which is sloped inward toward the body 302 of the female component 104. The female component 104 also includes a pair of wings 318 cantilevered from opposite sides of the body 302. The wings 318 are relatively wide in the X and Y axes and thinner in the Z axis, and are curved or bent downward, as viewed in FIGS. 1-3, so that when assembled as shown in FIG. 1, in a relaxed state the outer edges of the wings extend close to or beyond a plane defined by bottoms of the jaws, as viewed in FIG. 1.

FIGS. 4 and 5 are cross-sectional views of a temporary isolation system 400 that includes a plurality of clip assemblies 100, one of which is shown in use. The section of FIG. 4 is in an X-Z plane taken along lines 4-4 of FIG. 5, while the section of FIG. 5 is in an Y-Z plane taken along lines 5-5 of FIG. 4. As shown in FIGS. 4 and 5, the male and female components 102, 104 of the clip assembly 100 are coupled together in a manner similar to that shown in FIG. 1.

As was noted above, a typical suspended ceiling system includes a grid, hung from structural elements of a building, that is made up of T-bars, T-rails, or tees (hereafter, tees), comprising main tees extending parallel to a first horizontal axis and cross tees extending parallel to a second horizontal axis and between respective pairs of the main tees. Acoustic tile panels are supported on the lower flanges of the tees in the openings formed by the main and cross tees. Such systems are very well known and understood in the art, and so will not be described in detail here.

FIGS. 4 and 5 show a small portion of such a suspended ceiling system 402, including a tee 404, which is part of a ceiling grid, extending parallel to the Y axis. The tee 404 includes a keel 406 and a bottom flange 408, with the keel coupled edgewise down a center of the flange. The grid is suspended by any of a number of structures that are well known in the art, depending upon the particular design and manufacturer of the ceiling system 402. Ceiling tiles 410 are supported by the flange 408 of the tee 404, together with flanges of additional tees of the grid that extend along each side of each of the ceiling tiles. The width of the flange 408 may vary significantly by manufacturer and model, although most are slightly less than one inch wide; 15/16 inch is the most common, but widths of ½ inch, ¾ inch, 24 mm, 1 inch and 1½ inch are also encountered.

The temporary isolation system 400 provided by the present invention includes a plurality of clip assemblies, connected to the ceiling system 402 at regular intervals along the paths of vertical walls or curtains of the system 400 and distributed over areas in which sheeting is supported horizontally below the ceiling. The clip assembly 100 shown in FIGS. 4 and 5 is a representative example of the plurality of assemblies. PE sheeting 412 or a similar sheeting material forming the isolation barriers of the system 400 is attached to the ceiling system 402 and firmly held in place by the clip assemblies 100, as is described in greater detail below.

As is shown in FIGS. 4 and 5, in typical use, the clip assembly 100 is oriented upside down relative to the orientation shown in FIGS. 1-3, so as to depend from the tee member to which it is attached. The jaws 206 of the male component 102 grip, or engage opposing edges of the flange 408 of the tee 404, securely holding the clip assembly 100 to the ceiling grid. The female component 104 is positioned over the male component 102 from beneath, trapping the sheeting material between. The feet 214 of the male component 102 are inside the hollow body 302 of the female component 104 with the shaft 204 extending through a hole in the sheeting 412 and through the aperture 306, and the hollow body biased against the shoulder surfaces 208 of the jaws 206. The ratchet head 312 of the female component 104 extends partially through a space between the legs 212 of the male component 102 with the engagement notches 314 of the ratchet head 312 engaging the pawl edge 218 of the shaft 204, thereby locking the female component in position. Because of the relative dimensions of the male and female components 102, 104, and the shape of the wings 318 of the female component, the wings are flexed outward against a bottom surface 502 of the tee 404 of the ceiling grid system 402, with the PE sheeting 412 held tightly against the bottom surface by a spring bias applied by the wings against the bottom surface.

Overall dimensions of the clamp assembly 100 can vary, depending, in part on the dimensions of the tee 404. As noted above, in typical ceiling systems the flange 408 is generally between about ½ inch (13 mm) and about 1½ inches (38 mm) wide, with 5/16 inch being most common. The jaws 206 are sized and spaced so as to accommodate tees with a particular width or range of widths. Other dimensions vary accordingly. According to an embodiment, the base of the male component 102 is about 1% inches wide in the X axis, at the widest point of the jaws, and about 2% inches long in the Z axis, so that in use, the point 210 of the male component 102 is about 2 inches from the bottom surface 502 of the tee 404. The body of the female component 104 is about N inches in diameter, and about % inches in thickness (in the Z axis).

The number of clamp assemblies required for a given project will vary according to a number of factors, which may include, for example, the total length of vertical barrier required to fully enclose the area to be isolated, and the dimensions of any spaces that will require a horizontal barrier suspended below the ceiling; the weight of the barrier material that will be supported by the clamp assemblies (which in turn will depend upon the height of the ceilings, the thickness and number of layers of the material, etc.); the anticipated amount of foot traffic—i.e., the number of individuals working or passing—in the immediate vicinity of the barrier, and that might be expected to frequently touch or brush against the barrier; the length of time the barrier will be expected to remain in place; whether the barrier will be subjected to wind or significant pressure differentials; etc. Such issues are familiar to those of ordinary skill in the art, and so will not be discussed in significant detail, but for example, for a hypothetical project it might be determined that a preferred distribution is one clamp assembly about every 18-24 inches along a vertical barrier curtain, and an array of rows and columns of clamp assemblies about 3-4 feet apart where a barrier is to be supported horizontally against a ceiling. With such a determination, appropriate measurements can be taken and the number of clamp assemblies necessary can then be found using a simple mathematic calculation.

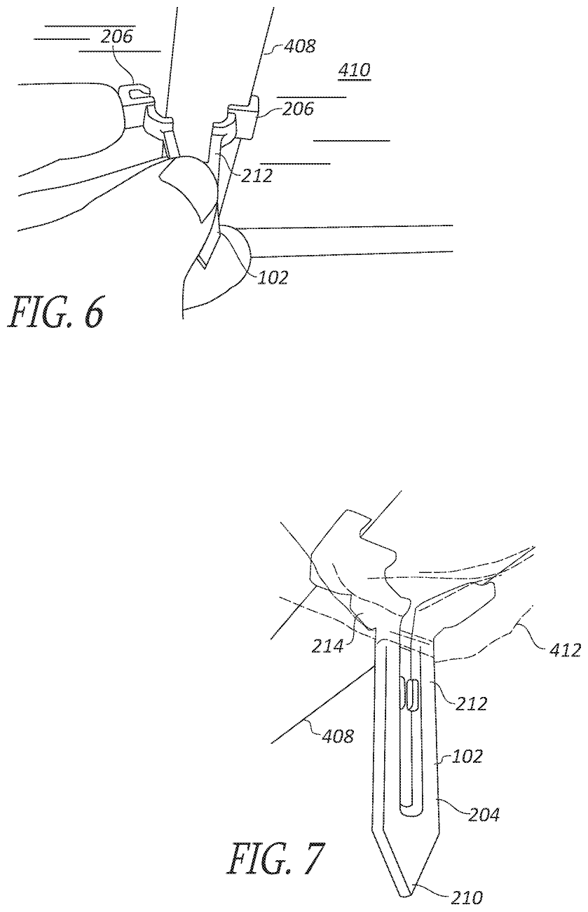

A method of installation and operation is described hereafter with reference to FIGS. 6-9, according to an embodiment. Upon determination of a desired distribution of the clamp assemblies, the approximate location of each assembly is established, and, if necessary, the point where a tee of the suspended ceiling system passes closest to each location is marked. Marking can be done with a light pencil mark, a small piece of removable painters tape, or any other appropriate removable or erasable marking method. Each of the clamp assemblies is installed in substantially the same manner, as described below, with reference to a representative example.

The male component 102 of the clamp assembly 100 is first installed at the selected location on the tee. While standing on a ladder or scaffold or the like, the user engages the jaws 206 of the male component 102 with opposite edges of the bottom flange 408 of the tee 404. This can be done as shown in FIG. 6, for example, by holding the male component generally by its shaft and fitting one of the jaws 206 over a first edge of the flange 408, then pushing/pulling the second jaw away from the engaged side of the flange, so as to flex the legs 212 apart until the second jaw 206 is able to clear the opposite edge of the flange. As this is done, the user then rotates the point 210 of male component 102 downwardly about the pivot formed at the first edge of the flange 408 so as to raise the second jaw 206 into alignment with the second edge of the flange, at which point the second jaw is released to engage the latter. The male components can thus be mounted to the tees of the grid in an exceptionally quick and efficient manner. This may also be done using only one hand, for example, by slipping the jaw on one leg over a first edge of the flange 408 while more-or-less simultaneously pushing/pulling the opposite leg between the thumb and finger(s) of the same hand so as to spread the legs and slip the second jaw over the other edge of the flange, all in one rapid and fluid motion.

Next, holding the PE (or other) sheeting 412 in the desired position, the user presses the sheeting upward against the point 210 of the male component 102, causing the point to pierce the sheeting, which the user then slides up the shaft 204 until the resulting hole in the sheeting contacts the feet 214 of the male component, as shown in FIG. 7. The dimensions of the feet 214 are greater than those of the shaft 204 in both the X and Y axes, which prevents the PE sheeting from sliding beyond the point where the legs 212 join the feet 214.

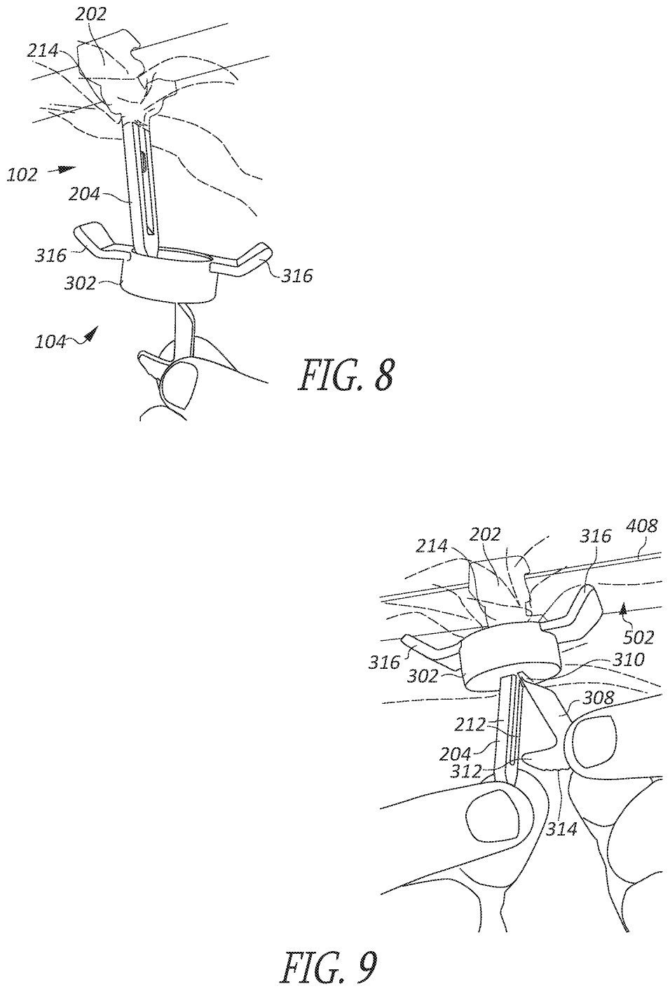

Next, or simultaneously, the user positions the female component 104 to introduce the shaft 204 into the aperture 306 in the body 302 of the female component, as shown in FIG. 8, and slides the female component along the shaft until the feet 214 of the male component 102 are at least partially inside the hollow body of the female component 104. This step may be performed in combination with that in the preceding paragraph rather than separately, e.g., by positioning the female component on the underside of the sheeting and lifting the female member so that the shaft of the male member pierces the sheeting at the same time that the female member is pressed into place.

The narrowed region 310 that connects the ratchet arm 308 to the body 302 of the female component 104 is sufficiently thin, in the Y axis, to give the narrowed region a degree of flexibility so as to act as a hinge, permitting the ratchet arm and ratchet head 312 to rotate, in a Y-Z plane, about an axis parallel to the X axis. This permits the user to rotate the ratchet head 312 away from the shaft 204 of the male component 102 as the female component 104 slides along the shaft 204. Then, as shown in FIG. 9, the user rotates the ratchet arm 308 back toward the shaft 204 until the end of the ratchet head 312 passes into the space between the legs 212 of the male component 102. As the user rotates the ratchet arm 308 inward, the engagement notches 314 along the sloped outer face 316 of the ratchet head 312 begin to engage the pawl edge 218 of the male component 102. Continued rotation of the ratchet arm 312 causes the pawl edge 218 to be engaged by notches 314 further up the slope of the outer face 316, which applies a steadily increasing force—transmitted by the ratchet arm—to the body 302, in a direction along the Z axis, toward the base 206 of the male component 102. In response to this applied force, the wings 316 of the female component 104 are biased against the lower face 502 of the tee while the body 302 is pressed tightly over the feet 214 and against the shoulder surfaces 208 of the jaws 206, biasing the jaws toward each other so that they tightly grip the flange 408. If the user applies excess force in rotating the ratchet arm 308, an inner surface of the ratchet arm 308 contacts the ratchet stop tabs 216, which prevents the ratchet head 312 from being pushed completely through the space between the legs 212. Thus, similar to the male component, installation of the female component can be performed quickly and efficiently using the fingers of only one hand.

According to an embodiment, initial engagement and locking of the ratchet head 312 with the pawl edge 218 is automatic. The user initially pulls the ratchet arm 308 clear of the shaft 204 as the female component 104 is moved along the shaft, but releases the ratchet arm once the ratchet head 312 is clear of the point 210 of the shaft. When the ratchet arm 308 is released, spring action of the narrowed region 310 biases the ratchet arm 308 toward engagement, so that the end of the ratchet head bears against the surface of the shaft 204 at the first end 211. As soon as the female component 104 is advanced to a point where the ratchet head 312 is able to move further inward, the spring action of the narrowed region causes the ratchet arm 308 to further rotate, carrying the ratchet head 312 into the space between the legs 212 of the shaft until the pawl edge 218 is engaged by one of the engagement notches 314. Thereafter, the user merely applies additional inward rotational force to the ratchet arm 308 to increase the gripping force of the clamp assembly 100 on the PE sheeting, or alternatively, applies upward force on the female component 104 against the spring bias of the wings 316 and moving the body 302 of the female component further along the shaft 204, permitting the ratchet arm to rotate further in response to the spring action of the narrowed region.

The term grip is used herein to refer to an action in which force is applied on one side of an element, e.g., the PE sheeting, that is being gripped, and that is opposed on a side of the element opposite, so that the element is pressed, or gripped between the applied force and the opposing force. The grip can be, for example, between two elements of the clamp assembly, as shown in FIG. 4, in which the PE sheeting is gripped between the male and female components 102, 104 or between one element of the clamp assembly and a structural element of the ceiling, as shown in FIG. 5, in which the PE sheeting is gripped between the wings 316 of the female component and the bottom surface 502 of the tee 404.

It can be seen, particularly with reference to FIGS. 4 and 5, that the grip of the clamp assembly 100 on the PE sheeting 412 is distributed across several contact points and surfaces: first, a portion of the PE sheeting 412 is captured inside the body 302 of the female component 104, between the body and the feet 214 of the male component 102. According to an embodiment, the respective shapes of the interior of the body 302 and the feet 214 cooperate to hold tightly the portion that is captured. Additionally, another portion of the sheeting 412 is held between a rim of the hollow portion of the body 302 and the shoulder surfaces 208 of the jaws 206. Finally, when the wings 316 are pressed against the lower surface 502 of the tee 404, the wings are caused to flex outward, and as a result apply a continuous spring bias against portions of the sheeting 412 that are held between the wings and the tee.

Although there are a few known devices that are designed to attach barrier material to a ceiling grid, none of the devices that are known to the inventor are configured to apply gripping force to more than a relatively small area of a barrier sheeting, and some do not apply any gripping force, but only provide hooks onto which the sheeting is pierced and hung. The relatively larger or broader surface that is gripped by embodiments of the clamp assembly disclosed above tends to resist tearing, and can potentially reduce the number of clamp assemblies required for a given application, as compared to prior art systems.

Additionally, it will be noted that according to the embodiment described with reference to FIGS. 4 and 5, the PE sheeting is pressed against the bottom surface of the tee in the Y axis, and in the X axis is held in a position that is separated from the plane defined by the bottom surface of the tee by less than half the thickness of the jaws 206. In other words, the clamping assemblies of the present disclosure are configured to hold the sheeting very close to, or directly against the surface of the ceiling, which simplifies the task of creating a seal between the sheeting and the ceiling—typically, the seal is made using duct tape or the like. Other known systems hold the barrier sheeting spaced some distance away from the ceiling, which, compared to systems disclosed herein, requires a more complex seal and increases the time, materials, and effort necessary to create the seal.

Another advantage provided, according to some embodiments, is that the clamp assembly is reusable, and requires no more time in disassembly than was required in the initial assembly. When a temporary isolation barrier is to be disassembled, the user simply reverses the steps described above with reference to FIGS. 6-9. Once the ratchet arm 308 is rotated outward and away from the shaft 204, the female component 104 slides easily away from the male component 102, which releases the PE sheeting and enables the easy removal of the male component from the tee 404. The male and female components 102, 104 can be reengaged for storage, and reused when a barrier is again required.

A further advantage of various embodiments is that locking the clamp assembly to the flange and clamping the sheeting to the assembly are performed during the same process step, i.e., when the female component 104 is slid onto the shaft 212 of the male component 102 and locked in place by rotation of the ratchet arm 308, this action simultaneously locks the clamping assembly 100 to the ceiling grid and applies broad gripping force to the PE sheeting. This is in contrast to at least one known system, in which separate parts are first engaged to lock the device to a tee, then further steps are performed and an additional part is connected, to grip a barrier sheet.

According to the embodiments disclosed herein, the male and female components 102, 104 of the clamp assembly 100 are each manufactured as a single monolithic piece. This is a particular advantage, inasmuch as it reduces manufacturing and packaging costs, will generally enable more compact storage, and simplifies handling, relative to devices that employ three or more components. This is also advantageous during use, inasmuch as handling time during use is also reduced, relative to systems that employ additional parts. It will be understood that a typical isolation system may employ a large number of clamping assemblies, and that a small amount of time saved or consumed in the installation and later removal of each individual assembly can result in a significant amount of total time that is either saved or expended over the entire project.

The clamping assembly can be manufactured using, for example, well known and understood injection molding processes, using polypropylene, polythene, abs or nylon, for example. It is within the abilities of one of ordinary skill to adapt such processes for the purpose of manufacturing clamp assemblies in accordance with embodiments of the present disclosure. Other embodiments are contemplated in which one or both of the male and female components are made from multiple parts that are assembled together to form the respective components.

Embodiments are described for use with polyethylene sheet material, but this is by way of example, only. The clamp assembly of the embodiments disclosed above can be used, or modified for use with many types of sheeting, including other plastic formulations, Tyvek®, Mylar®, paper, woven and non-woven fabrics, etc.

Elements of the clamp assemblies described above are shown with particular shapes, for the purposes of providing clear descriptions. However, other embodiments are contemplated in which different shapes are provided. For example, the shaft 204 is shown with a sharpened point 210. In practice, the degree of sharpness necessary to enable a user to cause the point to pierce even heavy gauge PE sheeting is very low as compared, for example, with the sharpness of a typical knife blade, screw, or nail. The point 210 can be made much less sharp than as shown without significantly increasing the force required to pierce the sheeting. Furthermore, many other edge geometries can be employed for similar results. Nor is the degree of force required to cause the point 210 to pierce the sheeting an essential aspect of the invention. Embodiments, such as those disclosed herein, in which the point is relatively sharp, require relatively little force to cause the point to pierce heavy gauge plastic, while other embodiments are contemplated in which the necessary force is much greater than is the case with a sharpened point like that described above. Such embodiments may be used in applications where a sharp point on the downward directed shaft might pose a minor hazard to passing traffic.

The pawl edge 218 is also shown as being relatively sharp. According to another embodiment, the pawl edge 218 is more rounded, while the engagement notches 314 of the ratchet head 312 are smoother and shallower than shown. This enables disengagement of the ratchet head 312 from the pawl edge 218 with less effort than with embodiments in which the pawl edge sharply and deeply engages the notches of the ratchet head.

The abstract of the present disclosure is provided as a brief outline of some of the principles of the invention according to one embodiment, and is not intended as a complete or definitive description of any embodiment thereof, nor should it be relied upon to define terms used in the specification or claims. The abstract does not limit the scope of the claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A device, comprising:
a first component that is formed as a single piece, and that includes:
a shaft element configured to pierce a sheet material, and
a clamping element sized and configured to engage opposing edges of a flange of a T-shaped rail of a suspended ceiling system; and
a second component configured to mate with the first component, lock the first component to the flange, and apply gripping force to a sheet material impaled on the shaft element.

2. The device of claim 1, wherein the second component is configured to lock the second component to the first component

3. The device of claim 1, wherein the second component is of a single piece of material.

4. The device of claim 1, wherein the clamping element comprises a pair of jaws that are biased toward each other, and that can be separated against the bias a distance sufficient to be positioned on opposite sides of the flange of the T-shaped rail.

5. The device of claim 1, wherein the second component comprises first and second gripping wings extending outward on respective sides of the second component and configured to apply a spring bias against a surface of the T-shaped rail while mated with the first component.

6. The device of claim 1, wherein the first component comprises a pawl element and the second component comprises a ratchet element configured to engaged the pawl element while the second component is mated with the first component, the ratchet element being further configured such that deeper engagement of the ratchet element with the pawl element increases the gripping force applied by the second element.

7. A device, comprising:
a first component that is formed as a single piece, and that includes:
a sheet engagement element configured to engage a sheet of material, and
a rail engagement element sized and configured to engage opposing edges of a flange of a T-shaped rail of a suspended ceiling system; and
a second component formed as a single piece and configured to removably mate with the first component and apply gripping force to a sheet of material engaged by the first device.

8. The device of claim 7 wherein the sheet engagement element is configured to engage the sheet of material by piercing the sheet of material.

9. The device of claim 7 wherein the second component is configured to lock the first component to the flange.

10. The device of claim 7 wherein the first component includes first and second legs, each having a jaw configured to engage a respective side of the flange, and wherein the second component is configured to prevent separation of the legs, locking the first element to the flange.

11. A method, comprising:
separating a pair of jaws of a first element against a spring bias tending to urge the pair of jaws toward each other;
while separating the pair of jaws, positioning the first element with the pair of jaws on opposite sides of a flange of a T-shaped rail of a suspended ceiling system;
allowing the pair of jaws to engage the opposite sides of the T-shaped rail by releasing the separation of the pair of jaws while the first element is positioned with the pair of jaws on opposite sides of the T-shaped rail;
locking the jaws of the first component in engagement with the flange by mating a second component with the first component.

12. The method of claim 11, comprising impaling a sheet material on a piercing element of the first component, and wherein the mating a second component with the first component comprises applying a gripping force to the sheet material impaled on the piercing element.

13. The method of claim 12, wherein the applying a gripping force to the sheet material comprises applying a gripping force between the second element and the first element.

14. The method of claim 12, wherein the applying a gripping force to the sheet material comprises applying a gripping force between the second element and a surface of the flange.

15. The method of claim 11, wherein the mating a second component with the first component comprises engaging a ratchet element of the second component with a pawl element of the first component.
